(19) United States
(12) Patent Application Publication
(10) Pub. No.: US 2002/0198963 A1
(43) Pub. Date: Dec. 26, 2002

(54) Method of timer based download and playback scheme for internet browser

(76) Inventors: Alex C. Wu, Fremont, CA (US); Sam Zheng Pan, Oakland, CA (US)

Correspondence Address: Alex C. Wu, 5457 Sunstar Common, Fremont, CA, 94555, US

(21) Appl. No.: 09/886,224

(22) Filed: Jun. 21, 2001

(51) Int. Cl. G06F 15/16; G09G 5/00

(52) U.S. Cl. 709/219; 345/748

(57) ABSTRACT

The invention is disclosed as a scheme for use in a browser application to schedule the download of the documents from a list of source server uniform resource locators in a networked environment at a specified time, and for a specified duration, and with a specified time interval. It can optionally save the downloaded documents onto a local storage, or storage at local network, or on a remote storage. The document downloaded over the network can be processed and rendered onto the browser at the specified time in the future. The invention further provides a scheme to schedule a download of the document based on a reference time embedded in the document downloaded from the source server.

### FIELD OF INVENTION

The present invention relates to the scheme used in Internet document viewing applications (a.k.a. Internet browser) on a networked devices, such as networked computer, an Internet enabled personal digital assistant (PDA) and cellular telephones. This invention provides a method to enhance the Internet browser to better perform the information retrieval and management. Users can download a document at a specified time, for a specified duration, with a specified time interval. It can optionally save the downloaded documents to a specified location for later processing. The users can also schedule the playback of the saved documents from the saved location. It will open and render the saved documents at a specified time, for a specified number of times, etc.

### BACKGROUND OF INVENTION

In recent decades, especially in the last five to ten years, computers have become interconnected by networks by an ever increasing extent, via local area networks (LANs), wide area networks (WANs) and the Inter-network (Internet). The Internet was originally developed as a military project to link the computers of the major academics and research institutes for information exchange and resources sharing. The most popular services for this computer network were email, network news, and chat for several years. Only after hypertext markup language (HTML) and the Internet browsing application were developed and freely distributed to the public, the Internet started to experience exponential growth due to commercial opportunities and public interests. The document over the Internet becomes more diversified and the major attractions to the public. The proliferation of networks, along with the increased availability of inexpensive data storage means, has afforded computer users unprecedented access to a wealth of data in the forms of text, graphics, images, audio, video, etc.

The growth of Internet and the documents not only provide the business opportunities, but also present the technical challenges to the users. Connecting to the Internet and retrieving document from the Internet has become almost a daily routine for more and more people. With so many sites available and so much information floating on the Internet, it becomes difficult to track what sites to visit and what time to visit them, users can easily forget when to retrieve important information. Currently, more information, for instance, the news site, or stock price quote site, as well as the online monitoring system, is dynamic generated and has the time-dependent nature, users may not be able to retrieve the documents when they are available due to schedule conflict or lack of Internet enabled devices at that moment.

Internet browser application, such as browsers from Netscape and Microsoft, requires users to reload the page by explicitly clicking a Reload or Refresh button. Although the server may offer options to the users to setup how frequent to download a page, so that the server may push the document to the client, or to define the refresh rate in the document, so that after downloading the document, the browser will reload the document again when time expires. However, the time interval is usually predefined on the server side and fixed in the document, the users do not have option to select any time interval they like. Besides, it still did not address when to initiate the download of the document from the source server site.

The speed of the download mainly depends on the network bandwidth and the load on the source server. Network bandwidth is always a problem on the Internet. When new bandwidth was added, it was quickly used up by new applications and new contents, such as Internet phone, audio, images, graphics, etc. It would be preferable to download the contents during off-peak hours when network is not heavily used.

Server load is another limitation which limits the speed with which documents can be downloaded by the browser client. For example, limitations in storage access time limits the speed with which a server can access a requested resource, when there are too many client requests coming in, some of the requests will not be served in a timely manner, some requests may not even be served at all. Some network protocol, such as FTP (file transfer protocol), can only take a limited number of client connections, it would be desirable to access the FTP servers when there are still open connection available. Basically, it would be preferable to download the contents during off-peak hours when the load on the server is less busy.

Some site offer time sensitive document. For example, on auction sites, most people prefer to access the auctioned items before they are closed for bid. In this case, it will be extremely helpful if we can have Internet browser scheduled to download the document at the specific time right before the item is about to be closed for bid, and provide the users with reminders before downloading the document.

A document will not be available after the provider of the document removes it. Also, a time dependent document will not be the same when accessing it at a different time, for example, morning news, stock price, etc. It would be desirable to give users flexibility to save these documents somewhere, so that these documents can be accessed later.

With current Internet browsers, such as the browsers from Netscape and Microsoft, the download operation will not start until the users provide a pathname to save the downloaded document. For the Internet browser with plugin application, it will automatically open the plugin application after downloading a certain type of document. For example, downloading a PDF document will automatically open an Adobe Acrobat Reader to render the document. Users will need to perform explicit operation in the Acrobat Reader to save the documents. However, In case users have schedule conflict and cannot perform the save operation, the download will not start, or the downloaded document will not be saved. It would be preferable to be able to save the downloaded documents automatically in a location specified by the users without prompting the users for the response.

When saving a downloaded document in an Internet browser, it would be desirable if users can choose where to save. For instance, users can choose to save to a local attached storage for the sake of privacy and speed, in other cases, users can choose to save to a network location so that the saved documents can be accessed from anywhere on the Internet.

After the documents have been downloaded and saved, it would be preferable to schedule the Internet browser to open the documents automatically at the specified time as a slide show with minimum intervention from the users, and users can choose the time interval to display the next slide.

In summary, the problems and frustrations of the users with the current Internet browsers are:

Users may forget to download the document at the specific time.

Users have conflict of schedule and cannot download the document at specific time.

Users want to schedule the download the documents when the network traffic is low.

Users want to schedule the download the documents when the server load is low.

Users want to schedule a download at any future time when document becomes available.

Users want to save the document somewhere after downloading the document, rather than rely on the server which may not carry the document any more.

Users want to save the document at the specified location for privacy, or convenience.

Users have conflict of schedule and cannot provide the response on save location.

Users do not want to manually reload the documents.

Users do not want to explicitly open the documents, rather than having browser automatically open the saved document at the specified time

Currently, HTML specifications offer a feature so that the server can provide a meta tag called Refresh header field in the downloaded webpage. For example,

<meta http-equiv=“Refresh” content=“30”>

will reload the same page after 30 seconds. This feature is called “Client Pull”. However, the Client Pull feature has the following disadvantages:

Internet browser cannot initiate the first download of this page at the specified time.

Internet browser cannot set the refresh time interval other than the one specified in the downloaded document.

Once the Internet browser download this page, the download will continue for infinite times until the users go to another page, or shutdown the Internet browser.

Inventors, over the years, have proposed some solutions from different aspects.

Stumm in U.S. Pat. No. 5,768,528 provides a method on the information server to deliver the contents to the clients which subscribe to the contents. However, the scheduling is not on the Internet browser, and this method does not have the capability for the user to setup the schedules.

Lowell in U.S. Pat. No. 6,012,086 provides a system (an apparatus, or a compute) to record video and audio content transmitted over the Internet. This invention does not address the scheduling need on the browser application, and the contents are specifically for video and audio contents. In addition, it does not provide any scheduling to manage the recorded contents.

Ultimate TV from Microsoft is a hybrid of digital video recorder, Internet device, and satellite receiver. It offers digital video recording to record TV program with signal coming from satellite dish, it also offer Internet browsing capability. However, it does not address the need to save the Internet content, also it did not provide user with the ability to save the content at the specified time.

This invention presented here addresses the problems, that the Internet users face, as features which can be added on to the Internet browser, or can be integrated into the Internet browsers.

A search of relevant patents reveals that none of the existing patents ever addressed the features of this invention. They are:

Empower the users to better manager the information

Provide download scheduler to retrieve the contents at the specified time

Users can setup the download in advance

Users can schedule a download during off-peak hours

Users can schedule a download when the server is less busy

The download can be performed when the users are away

Provide playback scheduler to automatically open the saved contents at the specified time

### SUMMARY OF INVENTION

The invention provides a method to enhance the Internet browser with DOWNLOAD SCHEDULER and PLAYBACK SCHEDULER to better manage the document retrieval and document management.

The preferred embodiment of the invention is an add-on and can be integrated with Internet browser, which is used on a network enabled devices, such as computer workstation, personal computer, Internet enabled wireless personal digital assistant, and Internet enabled cellular phones.

In the preferred embodiment of the invention, there is a DOWNLOAD SCHEDULER added onto the Internet browser, so that users can pre-program the Internet browser to retrieve contents from a list of sites at specified date and time, for a specified duration, at specified time interval between each retrieval. The time interval determines how frequent to download the pages.

In the preferred embodiment of the invention, users can select whether they want to save the downloaded content or not, if the users choose not to save the content, the time of the download is when the user want to view the contents

In the preferred embodiment of the invention, users can setup the Internet browser to download all types of the contents which can be delivered via Internet, and can be handled by the Internet browser, either natively or via plugin. The contents can be, but not limited to, hypertext mark-up languages (HTML) web pages, files, music, audio, video, and Internet broadcasting, etc.

In the preferred embodiment of the invention, users can choose whether to save the downloaded content or not, if the users choose to save the contents, the user can select the SAVE LOCATION to save the downloaded content. The save location can be:

default location (anonymous location), it can be cache directory of the Internet browser, the users do not have to provide the destination location

local storage of the network enabled device, or the storage in the local network environment, the users need to provide the destination location

remote storage over the Internet, the users need to provide the uniform resource locator (URL), or other identification to identify the destination location to save to. The advantages of this method is to allow the users to save the contents from the source server to a location, which can be retrieved from anywhere, as long as there is a Internet enabled devices.

DOWNLOAD EVENT has the following properties:

document UNIFORM RESOURCE LOCATOR (URL), the network location of the page to be downloaded

DOWNLOAD TIME properties, further comprising of

start date, the date to start the download

start time, the time to start the download

end time (or duration of the download), the time to stop the download, can be specified as either the end time or the duration of the download

time interval, the time interval between each contagious download

number of downloads, the number of downloads for the page between the start time and end time

isSave flag, a boolean flag, to indicate whether the pages downloaded from a site should be saved into a permanent storage or not. If the flag is true, the downloaded content will be saved to a permanent storage specified by the save location, if the flag is false, then the downloaded content will be displayed on the screen without saving to a storage when it is downloaded.

isView, a boolean flag, to indicate whether to view the download session. This flag is only used when isSave flag is true. If the isSave flag is true, then users can set isView flag to select whether to view the downloaded pages when they are being downloaded. If isView is true, a browser window will be used to display the page, if isView is false, then it will not display the content in the Internet browser window, the downloaded contents are saved to permanent storage automatically without user's intervention. If isSave is false, then the downloaded are always displayed on the Internet browser no matter what value isView is.

isNewWin, a boolean flag, this flag is to determine whether to start a new browser window to display the downloaded pages. This flag is used when either of the following two condition satisfies:

1. isSave is false

2. isSave is true and isView is true

Otherwise, this flag is ignored. This flag is a hint to the download scheduler and Internet browser, although users can set this flag to false to indicate the downloaded page should be displayed in the same window, if the download scheduler detects there exists an overlap of download time of the download event property, the pages from the earlier overlapped session will be displayed in the same window, the pages from the later overlapped session will however be displayed in a new window.

Once the properties for the DOWNLOAD EVENT is setup, the download event can be performed by the download scheduler at the specified time.

After the users setup the list of the download events, the system will perform the download with the interaction from the users.

In the preferred embodiment of the invention, users can choose to receive audible and/or visual alert on any of the following scenario:

when the entire download session has started

when it starts downloading from a new site

when a new page but different URL of the same site is downloaded

when a new version of the same page (same URL) is downloaded

The system may allow the users to use different alert for each different scenario.

In the preferred embodiment of the invention, after users setup the download time properties (start time, end time (or duration), time interval or number of downloads), if the user choose to view and view the downloaded pages, the pages will be displayed on the same browser window, however, if the download scheduler detects an overlap of download time with any of the existing download event, then it will display the pages in a new browser window.

In the preferred embodiment of the invention, the log of the download can be saved into a location for later examination, it is useful to find if the download is successful, or how long the download takes. In case of failure, the browser can provide with feedback indicator and at the same time to allow the users to re-download the pages immediately or schedule a new download event at a future time.

In the preferred embodiment of the invention, users can display the list of download events, and their status. Users can add more download events to the list, modify existing download events, or delete some of the download events even if they have not been performed yet. Users can set the preferences to remove the download events automatically when the events had been performed and successfully finished.

In the preferred embodiment of the invention, users can program the download scheduler to to download a specified site at a specified time without saving the contents to a storage. For this operation, the users can choose to receive reminder and/or alerts before or when the pages are downloaded.

In the preferred embodiment of the invention, users can program the download scheduler to download from a list of URLs (uniform resource locator), either immediately, or at the specified time, so that the users can view the contents when they are being downloaded. This feature offers the following advantages.

Users can setup a list of pages as daily routine, for example, it can automatically download and display morning news from news site in the morning, evening news in the evening, download and display road traffic document from traffic site right before the users will drive on the road for home, or for work.

Download scheduler will provide reminder and/or alert to the users before the down load, so that the users will not miss the schedule.

The downloaded contents are for display only, they will not occupy the storage space.

It is very useful on the pages which are highly time dependent, for example, auction items on auction sites. these pages need to be viewed right before bids end.

In the preferred embodiment of the invention, users can setup PLAYBACK SCHEDULER, an add-on to the Internet browser, so that users can pre-program the playback scheduler to open and view the saved contents, which were downloaded via the download scheduler, at a specified time. The playback scheduler can optionally provide alert and/or reminder before it starts to open and view the saved content in the Internet browser, or its plugin.

In the preferred embodiment of the invention, users can program the playback scheduler to open and display the saved pages of a specified site in either AUTOMATIC MODE or MANUAL MODE. If the users choose automatic playback mode for a specified site, then the playback scheduler will display the downloaded page from this site as in a slide show. If the users choose manual playback mode for this URL, then users need to explicitly open and view all pages from this site.

In the preferred embodiment of the invention, users can program the playback scheduler, so that the playback scheduler can open and display downloaded pages either once only or in LOOP PLAYBACK mode. The loop playback mode is after the playback scheduler has opened and displayed all of the downloaded pages, it can repeat the same operation again for the specified times.

In the preferred embodiment of the invention, users can set the following properties for the PLAYBACK EVENT in the playback scheduler.

page content size, it is the total size of the page, including embedded images, and scripts

show page text only size, this size is helpful for the users to set the time interval during playback.

automatic mode, or manual mode

play once or loop playback, whether to playback the saved contents once only or repeat for specified times.

time interval, time interval between two successive pages to be displayed.

In the preferred embodiment of the invention, users can choose to view the saved pages in automatic mode as in slide show. In the automatic mode, the users can set the time interval between any two downloaded pages to view saved page. The time interval can be different from the time interval of download scheduler, and each site can have different time interval. These features offer the following advantages:

Save typing, user do not have to type or click in automatic playback mode.

Some sites in general have more text contents on one page than other sites, in this case, users can set longer time interval for the site which has more text content to give themselves enough time to finish browsing the pages.

Usually the download of the page from the Internet is longer than opening the same page which had been saved due to the bandwidth limit of the connection, especially for dialup connection. It would be desirable to have playback time interval be shorter than the original download time interval.

In the preferred embodiment of the invention, users choose to download and save the pages and not to view the contents during downloading (isSave flag is true and isView is false). In this case, the download scheduler will not display the content in the browser window, and will not show any prompt dialog to interact with users. For example, in the current Internet browser, when downloading a file, the Internet browser will prompt the users for the location to save to, or ask the users whether to open the file, the browser will hold off the operation until it gets the response from users. With the download scheduler in this case, the download scheduler will not prompt the users, so that the download operations can continue without any interaction from the users. It simply uses the specified SAVE LOCATION to save the contents. This offers the following advantages:

Users can setup the download in advance

Users can setup the download during off-peak hours

Users can setup the download when the server is less busy

The download can be performed when the users are away

In the preferred embodiment of the invention, for a page which has the preferred download date/time displayed, users can highlight the time, and select download/reminder setup screen to setup the reminder time and download time to download this page. The date/time can be in several different format depends on the LOCALE (the language setting of the Internet browser), such as:

short, for example, 6/14/ 2001 8:23:46 AM PDT for U.S. locale

medium, for example, Jun. 14-01 8:23:46 AM PDT for U.S. locale

long, for example, June 14, 2001 8:23:46 AM PDT for U.S. locale

the format can also be in 24 hour format. The download scheduler will parse the date/time syntax and enable download/reminder setup screen button, so that the users can click this button to popup the download/reminder setup screen as shown in FIG. 12.

In the preferred embodiment of the invention, users can also highlight the date/time text on the displayed page as the REFERENCE TIME. and select use default download/reminder by clicking SETUP DEFAULT DOWNLOAD button, in this case, the reminder time will be set at 10 minutes before the reference time, download time will be set at 5 minutes before the reference time. and download again at reference time.

In the preferred embodiment of the invention, the REFERENCE TIME can be embedded in the header of the document via a meta tag, in this case, users can simply click SETUP DEFAULT DOWNLOAD button to setup the download event, so that the reminder time will be set at 10 minutes before the reference time, download time will be set at 5 minutes before the reference time, and download again at reference time.

These features are extremely useful in date/time related webpages, such as auction item pages on the auction sites, can highlight the end-of-bid date/time, a button will be enabled in the popup menu, or drop down menu, the users can click this button to display reminder/download time setup screen. This screen allows users to setup the reminder time and download time, so that Internet browser will alert the users at reminder time and perform the download of the page at the specified download time. After highlighting the date/time text, the users can also click SETUP DEFAULT DOWNLOAD, to have the download scheduler display a reminder at 10 minutes before the auction end-of-bid time, and download this page at 5 minutes before the end-of-bid time. This feature offers the following advantages:

Server side can provide the reference time in the document.

Users can schedule a download event with simple button click to setup download time, and reminder time based on the reference time embedded in the downloaded document.

Can provide reminder/alert to remind users the coming download event.

In the preferred embodiment of the invention, the functionality of download scheduler and playback schedule can be provided as a set of application programming interface (API) and command line interface, so that other application can utilize the functionalities of the new feature by invoking the set of download/playback scheduling API.

Conclusion

In view of the above, it can can be observed that among the very significant advantages offered by this invention is to empower the users to better manage the tasks of accessing document over the Internet by providing a download scheduler and playback scheduler.

### BRIEF DESCRIPTION OF THE DRAWING

FIG. 1 is a schematic representation of the Internet on which the clients access the servers on the Internet.

FIG. 2 is a diagrammatic representation of the download scheduler and playback scheduler with Internet browser according to the present invention.

FIG. 3 shows the a user interface to set the properties of download event.

FIG. 4 shows a graphical user interface screen to indicate whether to save the content, or just display the content without saving.

FIG. 5 shows a graphical user interface screen for the users to choose the save location.

FIG. 6 shows a graphical user interface screen to show whether to start the download in a new window

FIG. 7 shows a graphical user interface screen for users to manage download events.

FIG. 8 shows a graphical user interface screen for users to manage playback events.

FIG. 9 shows a graphical user interface screen for users to set playback control.

FIG. 10 shows a graphical user interface screen for users to set the playback event properties.

FIG. 11 shows a graphical user interface screen to setup a list of sites to download and display at specified time.

FIG. 12 shows a graphical user interface screen for the users to setup download events.

### DETAILED DESCRIPTION OF THE DRAWING

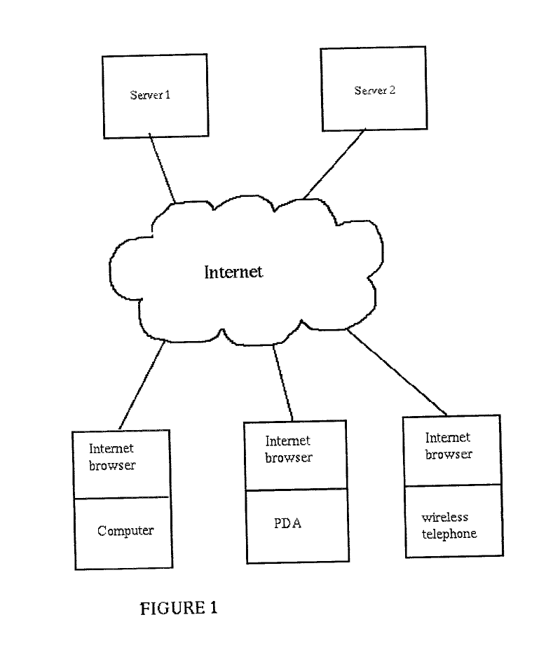

FIG. 1 illustrates the architecture of the Internet, network enabled devices, such as computer workstations, personal computers, personal digital assistant (PDA) and wireless cellular phone can access the source servers (Server 1 and Server 2) on the Internet via Internet browser.

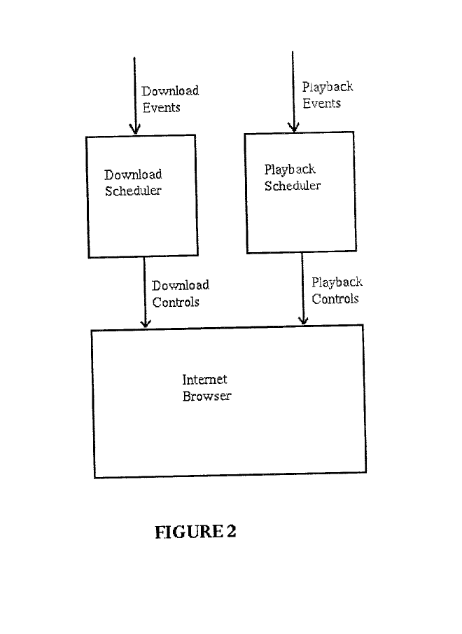

FIG. 2 illustrates both download scheduler and playback scheduler as add-on modules, they can be integrated into the Internet browser to enhance the functionalities of the Internet browser. The download scheduler gets the properties of the download events from the users, and it has control logics to schedule the download and display, it interfaces with Internet browser by passing the download event control document to the Internet browser, for example, to open a new browser window for the download session, etc. The playback scheduler can schedule playback events to open and display the saved contents via download scheduler. The playback scheduler accepts the properties of playback event from the users, and pass playback control document to the browser, such as to open saved content at specified time.

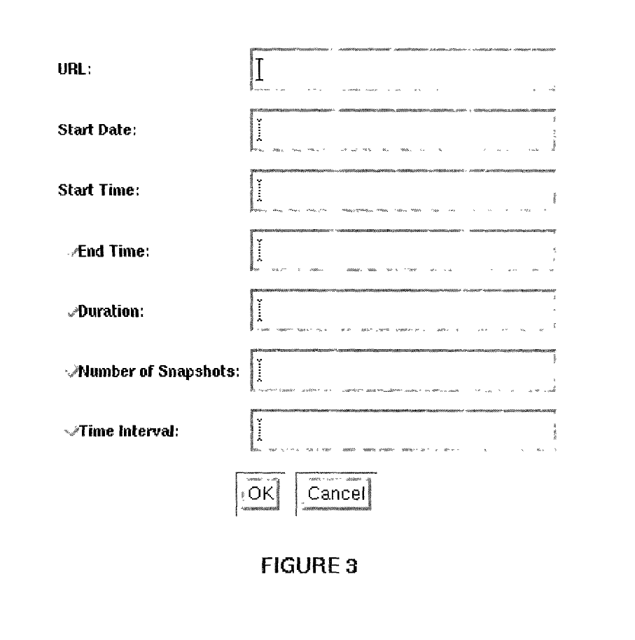

FIG. 3 illustrates the graphical user interface screen to set the properties of the download event. It allows user to specify the URL to download the content, set the start date, and start time to start the download session. The users can also specify either the duration or the end time of the download session, so that the download session will be terminated, even if the current download are not completely finished at end time, it will still be terminated but the partially download content will not be saved. In addition the users can also indicate how many times to download this page in the specified time range by specifying Number of Snapshots, or they can specify time interval between each between successive reload.

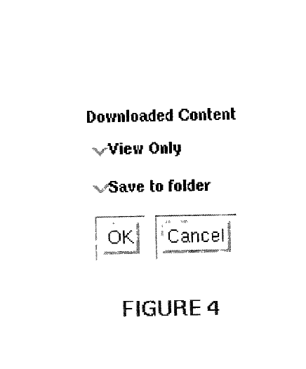

FIG. 4 illustrates the graphical user interface screen whether to save the content after the content has been downloaded. The users can choose “View Only” to view the content in the browser, or its plugin without saving the contents, or to save the contents in a permanent storage.

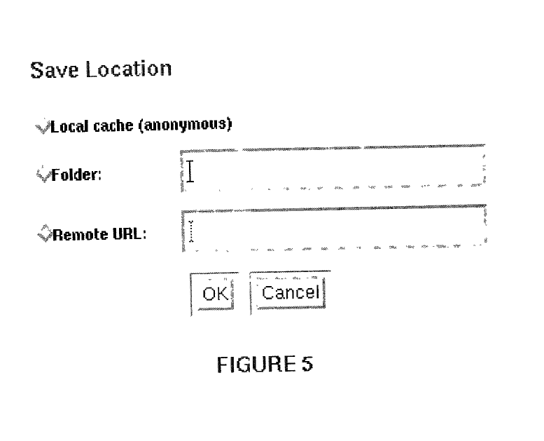

FIG. 5 illustrates the graphical user interface screen for the users to select where to store saved downloaded content, users can choose local cache, which is equivalent to the cache folder of the Internet browser, in this case, users do not need to specify a directory. Users can choose a named folder, which can be local storage, or remote storage which can be accessed via local area network. Users can also select remote folder, which can be in the form of uniform resource locator (URL), to specify any storage which can be accessed over the Internet.

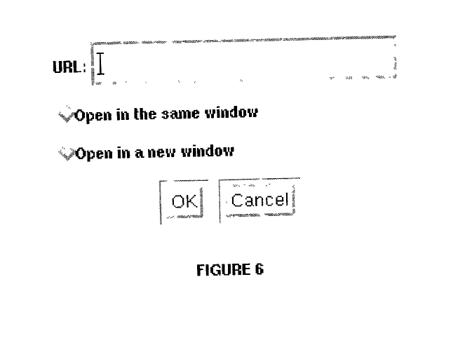

FIG. 6 illustrates a graphical user interface screen for the user to choose whether to start the download session in the same browser window, or in a new browser window. Normally, the same browser window is used to download the content unless the users explicitly indicate to open a new window in the download event. In some cases the download time can be extremely long, so it is better for the users to choose to open a new browser window to download and view the content. In addition, the download scheduler is smart enough to detect if a download event will have overlap in terms of time with other existing download events, and automatically open a new browser window for the download session when the scheduler is ready to start the download session.

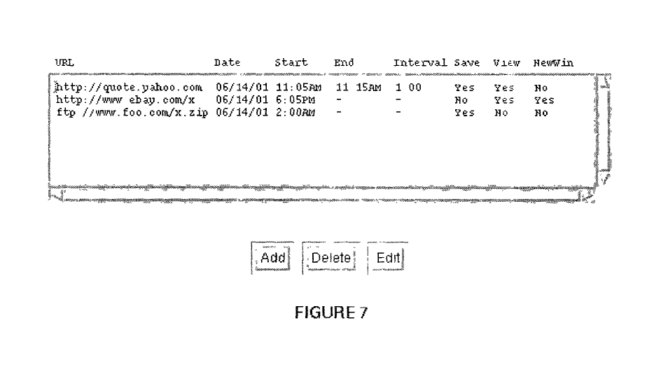

FIG. 7 shows a graphical user interface screen for users to manage download events, the users can add download events to the list, and delete a download event by selecting it from the list, or edit a download event by selecting it from the list. The first event is to download from URL at http://quote.yahoo.com, starts from 6/14/01 11:05AM, and ends at 11:15AM, it will retrieves the page every one minute, and will save the contents to the specified folder, it will display the page in the same browser window when it is being downloaded. In the figure, where

Date is the start date

Start is start time

End is end time, if the field is not specified, it means that the download session will not be explicitly ended until the download of the content has been completed

Interval is time interval to initiate the next download

Save is a flag to indicate whether to save the content or not

View is a flag to indicate whether to view the content on the browser when the content is being downloaded

NewWin is a flag to indicate whether to open a new window to view the content, or display the content in the same window

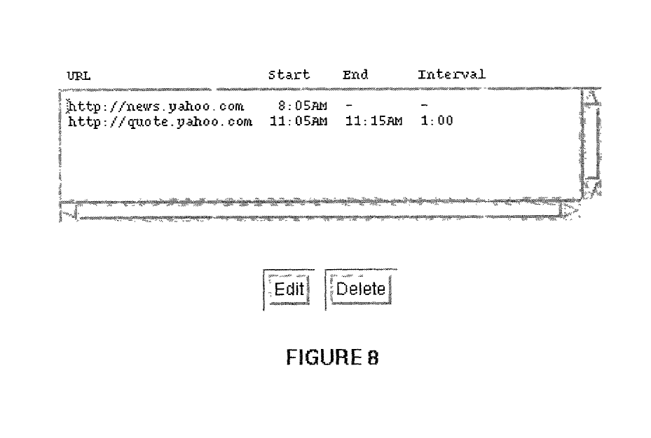

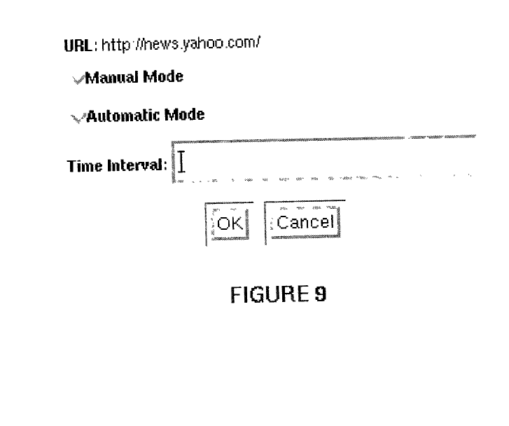

FIG. 8 illustrates a graphical user interface for users to manage playback events, the initial list is the list of URLs which has been downloaded and saved via download scheduler. Users can edit a item by selecting it from the list, or delete it by selecting it from the list. After users click Edit button, the users can edit the playback event as in FIG. 9. In this figure, where

URL is the URL of the source server to download the content from

Start is start time of the download

End is the end time of the download, if the field is not specified, it means that the download session will not be explicitly ended until the download of the content has been completed

Interval is the time interval between two successive reload of the same URL

FIG. 9 illustrates a graphical user interface for playback control screen, which is to control how to playback the saved contents. User can select either manual mode, or automatic mode for the playback, if users select automatic mode, they can set the time interval to reload the page. In this figure, where:

URL is the uniform resource locator where we have download the contents from

Manual Mode is a playback mode, users have to manually select the site item to open the contents which have been downloaded and saved

Automatic Mode. the browser will open and display the page automatically as a slide show

Time Interval is the time interval to reload the page.

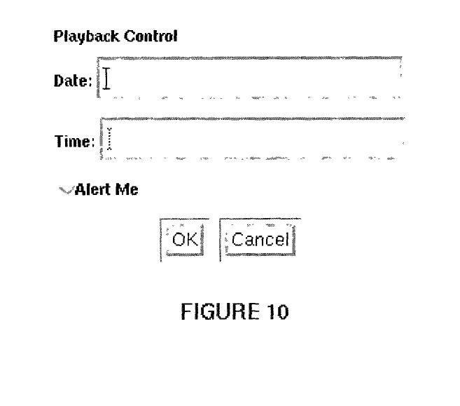

FIG. 10 illustrates a graphical user interface screen for users to set the properties of the playback event. Users can set the playback date and time to start the playback, users can also select whether to have playback scheduler to post a reminder/alert to the users.

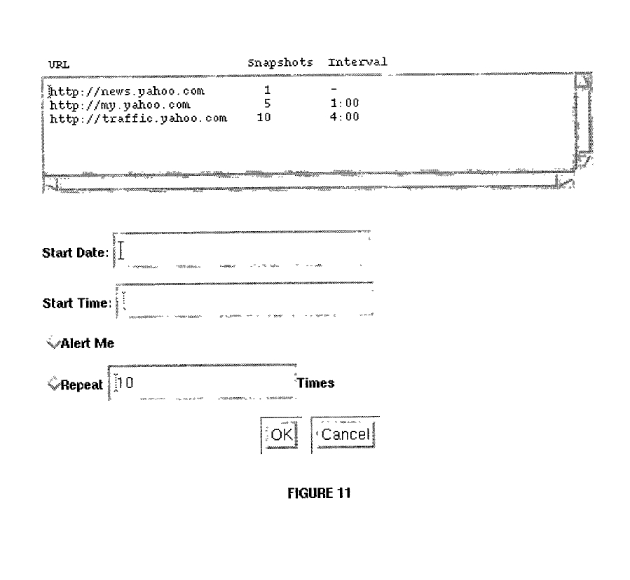

FIG. 11 illustrates a graphical user interface screen for users to setup a list of URLs to download and view at specified time. All of the sites in the list will be downloaded and displayed on the screen at start date and time, users can specify whether they want to have download scheduler to post a reminder/alert or not, and whether to repeat, and how many times, the entire download session after the list of sites have been downloaded once. In this figure, where:

URL is the URL of the page to view

Frame is number of frames to view this page, it is useful when the page content is dynamic

Interval is time interval for the next download of the page

Start Date is the date to start the entire download session

Start Time is the time to start the entire download session

Alert Me is the flag to indicate whether to provide reminder before downloading or not

Repeat is a flag to indicate whether to repeat the entire download session after the entire list of sites have been completed, if Repeat is true, users can set how many times to repeat

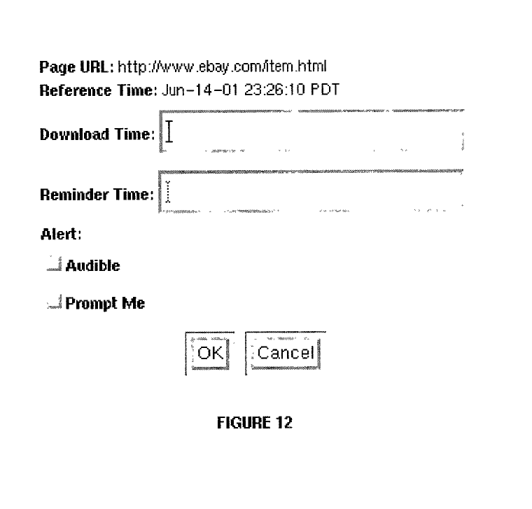

FIG. 12 shows a graphical user interface screen for the users to setup download events. This dialog is displayed after the users highlight the reference time from the page. and click Setup Download Event button. In this window, the URL of the page and the reference time will be displayed. The users can setup the download time, and the reminder time. The Users can also setup what kind of alerts they want to receive for the reminder.

We claim:

1. A method for scheduling a download of a document from a source server via a browser client on a networked apparatus comprising the steps of:
providing one or more fields for the entry of a source server, a start time, an end time, and
starting the download of the document from said source server at said start time, and
stopping the download of the document from said source server at said end time.

2. The method of claim 1, further including the steps to set a duration as a time period to end said download.

3. The method of claim 1, further including the steps to set a time interval as a time period between one download and the next download of said document.

4. The method of claim 1, further including the steps to set a number as the total number of download of said document.

5. The method of claim 1, further including the steps to set said end time as empty for said download which will continue until it finishes.

6. The method of claim 1, further including the steps to alert users for any overlapping of time period among scheduled downloads

7. The method of claim 1, further including the steps to set the reminder for posting reminder to users

8. The method of claim 1, further including the steps to set a new window flag for determining if said download will be performed by a new browser window of said browser.

9. The method in claim 1, further including the steps to set a view flag for determining if said downloaded will be rendered on the browser.

10. A method of claim 1, further including the steps to set a location for storing the downloaded document.

11. A method of claim 1, further including the steps to set a network location for storing the downloaded document.

12. The method in claim 1, further including the steps for saving the downloaded document to saved location directly, and bypassing the steps prompting users for the response of save location.

13. A method for scheduling a playback of a saved document via a browser client on a networked apparatus comprising the steps of:
providing one or more fields for the entry of start time, and
opening said saved documents at said start time, and
rendering the document onto said browser.

14. The method of claim 13, further including the steps to set the reminder for posting reminder to users.

15. The method of claim 13. further including the steps to set a time interval as a time period between opening one saved document and the next saved document.

16. The method of claim 13, further including the steps to set a number as the number of times to open and render the saved document.

17. A method for scheduling a download of a document from a source server via a browser client on a networked apparatus comprising the steps of:
download said document from said source server, and
scheduling said download at a start time according to a time stamp, and
starting the download of the document from said source server at said start time.

18. The method of claim 17 wherein said time stamp is embedded in the downloaded document from said source server.

19. The method of claim 17, further including the steps to set said start time.

20. The method of claim 17, further including enabling of the setup of said download scheduling based on the presence of said time stamp.

21. The method of claim 17, further including the steps to set a reminder for posting reminder to users.
